(19) United States
(12) Patent Application Publication
(10) Pub. No.: US 2002/0164455 A1
(43) Pub. Date: Nov. 7, 2002

(54) Porous sheet laminate and water resistant display sheet

(75) Inventors: Takehiko Nishikawa, Saitama (JP); Koiti Hirota, Saitama (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: LINTEC CORPORATION, Tokyo (JP)

(21) Appl. No.: 10/082,255

(22) Filed: Feb. 26, 2002

(30) Foreign Application Priority Data
Mar. 2, 2001 (JP) 2001-057899

(51) Int. Cl. B32B 3/00

(52) U.S. Cl. 428/172; 428/304.4

(57) ABSTRACT

Provided are a porous sheet laminate which can provide a display sheet having an excellent water resistance and suited to outdoor display and to which various printing and recording methods can be applied and a water resistant display sheet using the same. The porous sheet laminate is characterized by comprising a release sheet, an ink-receiving porous sheet and provided therebetween an adhesive layer endowed with a water-passing property, and the water resistant display sheet is prepared by providing in order a printing layer and a protective layer on the surface of the ink-receiving porous sheet in the above porous sheet laminate.

### BACKGROUND OF THE INVENTION

The present invention relates to a porous sheet laminate and a water resistant display sheet. More specifically, it relates to a porous sheet laminate which is excellent in a water resistance and can provide a display sheet suited for outdoor display and to which various printing and recording systems as well as an ink jet recording system can be applied and a water resistant display sheet using the same.

### RELATED ART

Known are recording sheets which are printed on surfaces thereof for the purposes of publicity, advertisement and providing information and which are displayed outdoors. These recording sheets are used after printing drawings and patterns on the surfaces thereof by various methods.

In recent years, as application techniques of computers come into wide use, data prepared by computers have come to be frequently printed out by means of printers. The printers used in this case include dot impact printers, laser printers, thermal printers and ink jet printers, and the ink jet printers are widely used because mechanical noises are scarcely produced in printing out and a running cost required for printing out is low. Further, printed-out matters have come to be displayed outdoors over a long period of time by changing an ink used in an ink jet printer to a pigment ink having an excellent weatherability.

In general, papers such as plain paper and coat paper are used for the recording sheet described above in many cases, and those using a plastic film as a base sheet are used as well. When using a plastic film as a base sheet, the base sheet is usually subjected to treatment for absorbing (fixing) a printing ink so that printing is easily carried out. Such treating method includes, for example, a method in which an ink-receiving layer is provided on the surface of a base sheet and a method in which a base sheet itself is provided with a porous structure having an ink-absorbing property (Japanese Patent Publication 56876/1988, Japanese Patent Application (through PCT) Laid-Open No. 510121/1999 and Japanese Patent Application Laid-Open No. 190630/2000).

When such printing sheet is subjected thereon to printing and displayed indoors or outdoors, usually taken is a measure for providing on a printing layer a protective layer having functions such as a UV ray-shielding function, a contamination resistance, an abrasion resistance, a water resistance and a scratching resistance in order to improve a durability of the printing layer.

When displaying outdoors a display sheet prepared by subjecting a recording sheet using an ink-receiving porous sheet as a base sheet to printing and providing a protective layer thereon, water and water vapor penetrate into the inside from a through hole exposed at the end face of the above ink-receiving porous sheet. In particular, when this penetrating water is shut up in the inside of the display sheet, it is considered that water is turned into water vapor by solar energy and that a very high pressure exerted by the water vapor is applied, and frequently caused is the trouble that the protective layer rises or peels off from a printing layer or the display sheet rises or peels off from an adhered matter.

In order to meet such trouble, the end face of an ink-receiving porous sheet has so far been subjected to sealing treatment for the purpose of preventing water from penetrating from the end face. A specific method for this sealing treatment includes a method in which a resin having no water-absorbing property is coated on the above end face. In such sealing treatment, however, not only treating operation is complicated but also it is difficult to completely carry out the sealing treatment, and the foregoing trouble caused by penetrating of water is less liable to be completely prevented from being caused.

### DISCLOSURE OF THE INVENTION

Under such circumstances, an object of the present invention is to provide a porous sheet laminate which can provide a display sheet inhibiting, even if displayed outdoors, rising or peeling off of a protective layer from a printing layer or rising or peeling off of the display sheet from an adhered matter caused by penetrating of water from the end face of an ink-receiving porous sheet and having an excellent water resistance and to which various printing and recording methods as well as an ink jet recording method can be applied.

Intensive researches repeated by the present inventors in order to achieve the object described above have resulted in finding that the object can be achieved by a porous sheet laminate having an adhesive layer endowed with a water-passing property between a release sheet and an ink-receiving porous sheet. The present invention has been completed based on such knowledge.

That is, the present invention provides:

(1) A porous sheet laminate comprising a release sheet, an ink-receiving porous sheet and provided therebetween an adhesive layer endowed with a water-passing property.

(2) The porous sheet laminate as described in the item (1), wherein the adhesive layer is provided with a concave groove or an irregularity part to be endowed with a water-passing property.

(3) The porous sheet laminate as described in the item (1), wherein a water vapor-permeating adhesive is used for the adhesive layer to be endowed with a water-passing property.

(4) The porous sheet laminate as described in the item (1), wherein a sheet having pores is inserted into the adhesive layer to endow it with a water-passing property.

(5) A water resistant display sheet prepared by providing in order a printing layer and a protective layer on the surface of the ink-receiving porous sheet in the porous sheet laminate as described in any of the items (1) to (4).

(6) The water resistant display sheet as described in the item (5), wherein it is used for ink jet printing.

### BRIEF DESCRIPTION OF THE DRAWINGS

FIG. 1 is a cross section showing one example of the structure of the porous sheet laminate of the present invention.

FIG. 2 is a cross section showing another example of the structure of the porous sheet laminate of the present invention.

FIG. 3 is a cross section showing one example of the structure of the water resistant display sheet of the present invention.

### EXPLANATION OF CODES

1: Ink-receiving porous sheet

2: Release sheet

3, 3a: Concave groove, irregularity part or an adhesive layer having a water vapor permeability.

3b, 3c: Adhesive layer

4: Sheet having pores

5: Printing layer

6: Protective layer

10, 10a: Porous sheet laminate

20: Water resistant display sheet

### EMBODIMENT OF THE INVENTION

The porous sheet laminate of the present invention comprises at least a release sheet, an ink-receiving porous sheet and provided therebetween an adhesive layer endowed with a water-passing property.

The ink-receiving porous sheet described above is a porous sheet having such an ink-receiving function that applicable is printing such as offset printing, flexo-printing, letter press printing, gravure printing, screen printing, ink jet printing, melt type heat transfer printing, sublimation type heat transfer printing, textile printing type heat transfer printing and electrophotographic printing.

This ink-receiving porous sheet can be produced by conventionally known methods (Japanese Patent Publication 56876/1988, Japanese Patent Application (through PCT) Laid-Open No. 510121/1999 and Japanese Patent Application Laid-Open No. 190630/2000), and it shall not specifically be restricted. For example, a sheet is prepared from the mixture of an inorganic powder, a polyolefin base resin and a paraffin base or naphthene base plasticizer, and then the plasticizer contained in the sheet is extracted by a solvent such as diethyl ether, acetone and toluene, whereby the ink-receiving porous sheet in which many holes communicate to provide through holes can be produced.

The ink-receiving porous sheet has a water-passing property provided by the communicating through holes.

The term “water-passing property” used in the present invention means that water and/or water vapor are liable to pass through in such a form.

In the present invention, the ink-receiving porous sheet has a thickness selected in a range of usually 10 to 500 μm, preferably 20 to 300 μm and more preferably 50 to 250 μm. The pore diameter falls in a range of usually 0.01 to 10 μm, preferably 0.05 to 1 μm.

The release sheet used in the porous sheet laminate of the present invention includes, for example, paper base materials such as glassine paper, woodfree paper and cast-coated paper; laminated papers prepared by laminating thermoplastic resins such as polyethylene on these paper base materials; and those prepared by coating release agents such as a silicon resin, an alkid resin and a fluororesin on plastic films such as polyester films of polyethylene terephthalate, polybutylene terephthalate and polyethylene naphthalate, polyolefin films of polypropylene and polyethylene, polyvinyl chloride films, polyvinylidene chloride films, polyvinyl fluoride films, polymethyl methacrylate films, polycarbonate films and ethylene-vinyl acetate copolymer films. The thickness of this release sheet shall not specifically be restricted and is usually an extent of 20 to 150 μm.

The adhesive according to the present invention shall not specifically be restricted, and conventionally known ones can be used.

Any of pressure-sensitive adhesives which have a stickiness at a room temperature and which can be adhered at a low pressure and heat-sensitive adhesives exhibiting an adhesive property by heating can be used as this adhesive.

Any of the acryl base, the rubber base and the silicon base can be used as the heat-sensitive adhesive.

In the case of the pressure-sensitive adhesive of the acryl base described above, included are, for example, those of an acryl base containing as an adhesive component, homopolymers of monomers selected from acrylic acid, methacrylic acid, acrylates and methacrylates, copolymers comprising plural monomers thereof and copolymers of these monomers with other copolymerizable monomers.

In the case of the pressure-sensitive adhesive of the rubber base, included are, for example, those of a natural rubber base, an isoprene rubber base, a styrene-butadiene base, a reclaimed rubber base and a polyisobutylene base and those comprising mainly block copolymers containing rubbers such as styrene-isoprene-styrene rubber.

The pressure-sensitive adhesive of the silicon base includes, for example, those of a dimethylpolysiloxane base and a diphenylsiloxane base.

The heat-sensitive adhesive includes, for example, those of a polyethylene base, an ethylene-vinyl acetate base, a polyester base and a polyurethane base.

Among them, the pressure-sensitive adhesive is usually preferably used.

Capable of being suitably added, if desired, to these adhesives for the purpose of elevating the durability and the other physical properties and the productivity are publicly known various additives, for example, antioxidants of a phenyleneamine base, a hindered phenol base, a phosphite base, a phosphonite base and a thioether base, UV-absorbers of a benzophenone base, a benzotriazole base and a triazine base, light stabilizers of a hindered amine base and the like, plasticizers of a phthalic acid base, a phosphoric acid ester base and a polyester base, cross-linking agents of an epoxy base, an isocyanate base and a metal chelate base, tackifiers such as terpene, rosin and terpenepenol and colorants such as dyes and pigments, and productivity-improving agents such as thickeners, defoaming agents, leveling agents and lubricants.

The adhesive layer having a water-passing property according to the present invention means an adhesive layer having a function in which water entering from the end face of the ink-receiving porous sheet can be drawn to the outside in the form of water and/or water vapor.

In the present invention, capable of being given as a method for providing the adhesive layer described above with a water-passing property are, for example, (1) a method in which the adhesive layer is provided with a concave groove or an irregularity part to be endowed with a water-passing property, (2) a method in which a material having an excellent water vapor permeability is used for the adhesive layer to endow it with a water-passing property and (3) a method in which a sheet having pores such as a nonwoven fabric and a foamed sheet having continuous bubbles is inserted into the adhesive layer to endow it with a water-passing property.

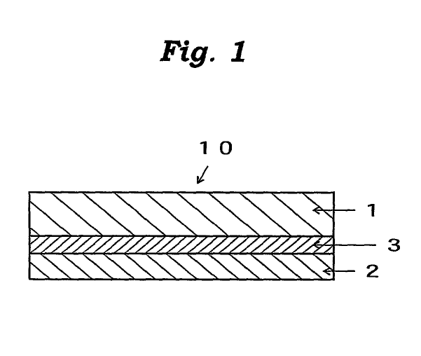

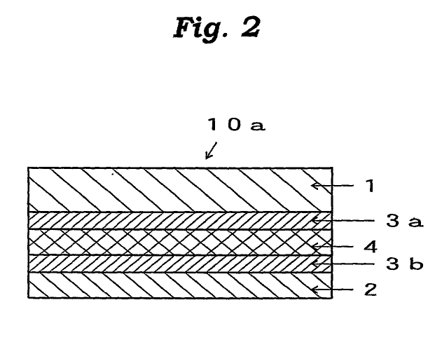

In the case of the methods (1) and (2) described above, the example of the structure of the porous sheet laminate of the present invention is the structure shown in FIG. 1, and on the other hand, the example in the case of the method (3) is the structure shown in FIG. 2.

In FIG. 1, an adhesive layer 3 having a concave groove can be formed on a face on which a release agent is coated in an ink-receiving porous sheet 1 or a release sheet 2 by, for example, a roll coater method using a comb blade. In the adhesive layer 3 having the concave groove formed in such a manner as described above, a striped concave part is formed on the adhesive layer, and the adhesive may not be applied on this concave part. Further, the form of this concave groove may be either linear or curved. The concave groove shall not specifically be restricted in a width and a pitch as long as the water-passing function can sufficiently be exhibited. On the other hand, the adhesive layer 3 having an irregularity part can be formed by, for example, a method in which an adhesive is applied on a release sheet provided with irregularities by conventionally known means, a method in which an adhesive is applied by a silk screen method and a method in which a sheet provided with an adhesive layer by conventionally known means is passed between engraved rolls. This irregularity shall not specifically be restricted in a form, a size and a distribution state as long as the water-passing function can sufficiently be exhibited. The adhesive may not be applied on the concave part in this irregularity part.

When a silicon base adhesive is used for the adhesive layer 3 in FIG. 1, this silicon base adhesive has an excellent water vapor permeability as compared with those of the other adhesives, so that such a concave groove or an irregularity part as described above does not have to be provided, and if a flat adhesive layer is provided by conventionally known means, the above adhesive layer itself functions as a water-passing layer. It is a matter of course that a concave groove or an irregularity part may be provided on this silicon base adhesive.

The water vapor permeability in the adhesive layer described above can be evaluated by the moisture permeability, and it is preferably 3000 g/m²·24 hours or more, more preferably 5000 g/m²·24 hours or more.

The thickness of the adhesive layer 3 in FIG. 1 shall not specifically be restricted and falls in a range of usually 5 to 100 μm, preferably 15 to 35 μm.

The coating method includes conventionally known methods, for example, a roll method, a roll knife method, a gravure method, a Mayer-bar method, a die method, a spray method, a curtain method and a screen method.

In FIG. 2 showing the example of the structure of the porous sheet laminate in which the sheet having pores in (4) described above is inserted into the adhesive layer to endow the adhesive layer with a water-passing property, a porous sheet laminate 10a has a structure in which a sheet 4 having holes is laminated on a release sheet 2 via an adhesive layer 3b and in which an ink-receiving porous sheet 1 is further laminated thereon via an adhesive layer 3a.

A nonwoven fabric and a foamed sheet having continuous bubbles are preferably used for this sheet having pores.

In this case, the nonwoven fabric shall not specifically be restricted, and conventionally known ones can be used.

Capable of being given as a fiber material for the nonwoven fabric are, for example, synthetic fibers of a cupra base, an acetate base, an acryl base, a polyester base, a polyurethane base, a vinylon base, a nylon base and a polypropylene base, inorganic fibers represented by glass and natural fibers such as wooden pulp and cotton.

This nonwoven fabric has a thickness falling in range of usually 30 to 300 μm, preferably 50 to 250 μm.

On the other hand, capable of being give as the foamed sheet having continuous bubbles are those prepared by mixing gas or dispersing it without mixing and mixing a volatile solvent in preparing sheets from various synthetic resins and molding them so that the holes are connected and those provided with continuous holes by using a foaming agent. The synthetic resins described above include, for example, polyurethanes, polyethylenes, polypropylenes, polystyrenes and polyacrylates. In the case of foamed polyurethane, capable of being used is a production method in which polyisocyanate is reacted with water to produce carbon dioxide to thereby foam polyurethane. Further, In the case of foamed polystyrene, known is a method in which styrene resin beads produced by suspension polymerization are impregnated with a low boiling hydrocarbon as a foaming agent and in which a film is produced from this.

This foamed sheet has a thickness falling in range of usually 10 to 300 μm, preferably 20 to 250 μm.

In producing the porous sheet laminate in the present invention, the adhesive layer 3a in FIG. 2 may be provided on the ink-receiving porous sheet 1, and the sheet 4 having holes may be laminated thereon, or it may be provided on the sheet 4 having holes, and the ink-receiving porous sheet 1 may be laminated thereon. Further, the adhesive layer 3b may be provided on the release sheet 2, and the sheet 4 having holes may be laminated thereon, or it may be provided on the sheet 4 having holes, and the release sheet 2 may be laminated thereon.

In the case of the adhesive layer into which a sheet having pores is inserted, it is advisable to endow the adhesive layer 3a with a water-passing property as is the case with the adhesive layer 3 described above, and the water-passing property of the adhesive layer 3b shall not specifically be restricted.

The adhesive in the adhesive layers 3a and 3b shall not specifically be restricted in a kind, a thickness and a coating method, and the same adhesive, thickness and coating method as used in the case of the adhesive layer 3a described above can be used.

Next, the water resistant display sheet of the present invention shall be explained.

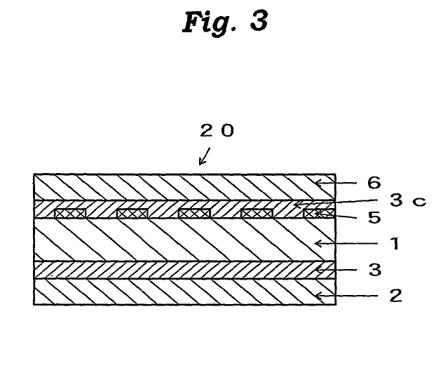

FIG. 3 is a cross section showing the structure of one example of the water resistant display sheet of the present invention. As shown in FIG. 3, the water resistant display sheet 20 of the present invention has a structure in which a protective layer 6 is laminated on a printing layer 5 in an ink-receiving porous sheet 1 provided thereon with the above printing layer 5 via an adhesive layer 3c and in which a release sheet 2 is laminated on a face opposite to the printing layer 5 in the ink-receiving porous sheet 1 via an adhesive layer 3 having a concave groove or an irregularity part or a water vapor permeability. It is a matter of course that a part or the whole of the printing layer 5 may be penetrated into the inside of the ink-receiving porous sheet 1 and formed therein.

The printing layer 5 can be formed by various printing methods.

The printing methods described above include, for example, offset printing, flexo-printing, letter press printing, gravure printing, screen printing, ink jet printing, melt type heat transfer printing, sublimation type heat transfer printing, textile printing type heat transfer printing and electrophotographic printing. When using particularly the ink jet printing among them, the water resistant display sheet of the present invention is suited thereto.

As a protective layer 6 provided on this printing layer 5, various laminate materials can be used without any specific restrictions as long as it is a transparent laminate materials having functions such as an abrasion resistance, a weatherability, a scratching resistance, a water resistance and a contamination resistance. Such laminate material includes, for example, a polyethylene film, a polypropylene film, a polyethylene terephthalate film, a polybutylene terephthalate film, a polyethylene naphthalate film, a polyvinyl chloride film, a polyvinylidene chloride film, a polyvinyl fluoride film, an acryl resin film, a polycarbonate film, an ethylene-vinyl acetate copolymer film, various polyamide films, an ionomer resin film and films provided on the surfaces thereof with an ionizing radiation-curing resin layer.

Capable of being suitably added, if desired, to these laminate materials for the purpose of providing them the durability and the like are various additives, for example, antioxidants of a phenyleneamine base, a hindered phenol base, a phosphite base, a phosphonite base and a thioether base, UV-absorbers of a benzophenone base, benzotriazole base and a triazine base, light stabilizers of a hindered amine base and the like and plasticizers of a phthalic acid base, a phosphoric acid ester base and a polyester base.

In the present invention, the protective layer 6 comprising the laminate material described above has a thickness falling in a range of usually 5 to 1000 μm, preferably 20 to 200 μm. Further, this protective layer 6 can be subjected on the surface thereof, if desired, to embossing finish for the purpose of elevating the decorative design property.

As shown in FIG. 3, the protective layer 6 can be formed by laminating the laminate material described above on the printing layer via the adhesive layer.

In FIG. 3, the same adhesive as used in the porous sheet laminate of the present invention described above can be used as the material of the adhesive and the additives constituting the adhesive layer 3c. The adhesive layer 3c may be provided on the printing layer 5, and the laminate material for forming the protective layer 6 may be laminated thereon, or it may be provided in advance on the laminate material for forming the protective layer 6, and this may be laminated on the porous sheet provided thereon with the printing layer 5. The adhesive has a thickness falling in a range of usually 5 to 100 μm, preferably 15 to 35 μm. Capable of being used as a coating method for the adhesive are conventionally known methods, for example, a roll method, a roll knife method, a gravure method, a Maier method, a die method, a spray method, a curtain method and a screen method.

Further, it is allowed to provide an ionizing radiation-curing resin layer directly on the printing layer and irradiate it with a UV ray or an electron beam and cure it to thereby prepare a protective layer.

When the water resistant display sheet 20 of the present invention thus obtained is used, for example, for outdoor display matters, the release sheet 2 is peeled off, and the display sheet 20 is adhered on an adhered matter via the exposed adhesive layer 3. When this is displayed outdoors, the protective layer is inhibited from rising or peeling off or the water resistant display sheet is inhibited from rising or peeling off from an adhered matter, even if water and water vapor penetrate from the end face of the porous sheet, so that the good appearance can be maintained.

Capable of being given as the adhered matter described above are, for example, plastic plates comprising polycarbonate and acryl resins, metal plates comprising aluminum and zinc and those obtained by coating these metal plates for the purpose of rust prevention.

### EXAMPLES

Next, the present invention shall be explained in further details with reference to examples, but the present invention shall by no means be restricted by these examples.

1) Outdoor display test

The water resistant display sheet obtained in each example was cut to 6 cm×6 cm, and then the release sheet was peeled off. It was stuck on a melamine-coated iron plate (brand name: Melamine White-Coated Iron Plate, manufactured by Paltec Co., Ltd.), and pressure was applied thereon by means of a laminator (brand name: Lamipacker, manufactured by Fujipla Co., Ltd.)

This sample was disposed outdoors toward the south at 45°, and the appearance thereof was visually observed after one month since disposed to evaluate the deficiency of the appearance based on the following criteria:

◯: no deficiency on the appearance

X: water vapor stays between the melamine-coated iron plate and the adhesive layer 3 in the water resistant display sheet and between the adhesive layer 3c and the ink-receiving porous sheet 1, and the deficiency of the appearance caused by rising and peeling is observed.

2) Moisture permeability test of the adhesive

An adhesive was applied on the release-treating face of a double sided polyethylene laminate paper having a thickness of 110 μm coated with a silicon resin release agent as a release sheet so that the thickness after drying was 30 μm to thereby form an adhesive layer. Then, a polyester mesh having no moisture retention (#400) was adhered on the adhesive layer.

Next, the opening of a round aluminum-made cup having a radius of 3 cm into which about 10 g of distilled water was put was covered with the adhesive layer exposed by peeling a release paper from the adhesive layer described above to prepare a test sample.

This test sample was left standing in a dry condition of 40° C. for 24 hours, and the weights of the test sample before and after left standing were measured to calculate the moisture permeability (g/cm²·24 hours) from the weight loss thereof.

### Example 1

(1) Preparation of a Porous Sheet Laminate

Used as the ink-receiving porous sheet was an ink-receiving porous sheet having through holes having a pore diameter of 1 μm or less obtained by preparing a sheet blended with 30% by weight of silica powder, 70% by weight of a polyethylene resin and a paraffin oil and then extracting the paraffin oil with acetone.

An acryl base adhesive (brand name: PA-10, manufactured by Lintec Co., Ltd.) was applied on one side of this ink-receiving porous sheet in the form of stripes by means of a die coater so that the applied part had a width of 2 mm and the unapplied part had a width of 2 mm and that the adhesive layer in the applied part had a thickness of 25 μm after drying, whereby an adhesive layer having concave grooves was formed.

Next, a double sided polyethylene laminate paper having a thickness of 110 μm coated thereon with a silicon resin release agent was stuck thereon so that the release-treated face thereof came in contact with the adhesive layer of the porous sheet described above, whereby a porous sheet laminate was prepared.

(2) Preparation of a Release Sheet-provided Laminate Material for a Protective Layer

Used as the release sheet was a polyethylene terephthalate film having a thickness of 25 μm coated thereon with a silicon resin release agent, and a transparent acryl base adhesive (brand name: PL Sin, manufactured by Lintec Co., Ltd.) was applied on the release-treated face thereof by means of a roll knife coater so that the thickness after drying was 25 μm. Then, a polyethylene terephthalate film having a thickness of 50 μm was stuck on this adhesive layer to prepare a release sheet-provided laminate material having a whole thickness of 100 μm for a protective layer.

(3) Preparation of a Water Resistant Display Sheet

Patterns were printed on the surface opposite to the side having thereon the adhesive layer in the ink-receiving porous sheet of the porous sheet laminate obtained in (1) described above by means of an ink jet printer to provide a printing layer. Then, the release sheet was peeled off from the release sheet-provided laminate material for a protective layer obtained in (2) described above, and this laminate material was stuck so that the adhesive layer thereof came in contact with the printing layer of the porous sheet laminate described above, whereby a water resistant display sheet having a whole thickness of 410 μm was prepared.

### Example 2

(1) Preparation of a Porous Sheet Laminate

The acryl base adhesive (brand name: PA-10, manufactured by Lintec Co., Ltd.) was applied on the release-treated face of a release sheet having a thickness of 110 μm provided with irregularities having a vertical interval of 15 μm at a lattice interval of 2 mm×2 mm (prepared by applying a silicon resin release agent on a double sided polyethylene laminate paper and then providing it with irregularities by applying pressure by means of a metal embossing roll having irregularities) so that the thickness after drying measured from the lower face of the concave part in the release sheet was 25 μm, whereby an adhesive layer having irregularities was formed.

Next, this release sheet was stuck on one face of the same ink-receiving porous sheet as used in (1) of Example 1 via the above adhesive layer to prepare a porous sheet laminate.

(2) Preparation of a Release Sheet-provided Laminate Material for a Protective Layer

The same procedure as in (2) of Example 1 was repeated to prepare a release sheet-provided laminate material having a whole thickness of 100 μm for a protective layer, except that in (2) of Example 1, a polyvinyl chloride film having a thickness of 50 μm (containing a benzotriazole base UV absorber, a hindered amine base light stabilizer and a phenyleneamine base antioxidant) as the laminate material for a protective layer was substituted for the polyethylene terephthalate film having a thickness of 50 μm.

(3) Preparation of a Water Resistant Display Sheet

Used were the porous sheet laminate obtained in (1) described above and the release sheet-provided laminate material for a protective layer obtained in (2) described above to prepare a water resistant display sheet having a whole thickness of 395 μm in the same manner as in (3) of Example 1.

### Example 3

(1) Preparation of a Porous Sheet Laminate

Used as the release sheet was a double sided polyethylene laminate paper having a thickness of 110 μm coated thereon with a silicon resin release agent, and a silicon base adhesive (brand name: SI-308NC, manufactured by Lintec Co., Ltd.) was applied on the release-treated face thereof as an adhesive layer having a water vapor permeability so that the thickness after drying was 30 μm, whereby an adhesive layer was formed.

Next, this release sheet was stuck on one face of the same ink-receiving porous sheet as used in (1) of Example 1 via the above adhesive layer to prepare a porous sheet laminate.

(2) Preparation of a Release Sheet-provided Laminate Material for a Protective Layer

The same procedure as in (2) of Example 1 was repeated to prepare a release sheet-provided laminate material having a thickness of 50 μm for a protective layer, except that in (2) of Example 1, a polyvinyl fluoride film having a thickness of 25 μm was substituted for the polyethylene terephthalate film having a thickness of 50 μm and that used as a transparent acryl base adhesive was a compound (brand name: LS401E, manufactured by Lintec Co., Ltd.) prepared by adding 1.5 part by weight of a benzotriazole base UV absorber to 100 parts by weight of the solid matter.

(3) Preparation of a Water Resistant Display Sheet

Used were the porous sheet laminate obtained in (1) described above and the release sheet-provided laminate material for a protective layer obtained in (2) described above to prepare a water resistant display sheet having a whole thickness of 390 μm in the same manner as in (3) of Example 1.

### Example 4

(1) Preparation of a Porous Sheet Laminate

The adhesive layer of an adhesive sheet prepared by forming an adhesive layer on the release sheet provided with irregularities obtained in (1) of Example 2 was stuck on one face of a nonwoven fabric having a thickness of 215 μm prepared by a wet method using a polyester fiber.

Next, stuck on the other face of the nonwoven fabric described above was the adhesive face of an adhesive sheet prepared by applying by means of a roll knife coater, an acryl base adhesive (brand name: PA-T1, manufactured by Lintec Co., Ltd.) on the release-treated face of a polyethylene terephthalate film having a thickness of 25 μm separately coated thereon with a silicon resin release agent and drying so that the thickness after drying was 25 μm to provide an adhesive layer, whereby the adhesive layer and the release sheet were provided on both faces of the nonwoven fabric.

Next, the release sheet provided with irregularities was peeled off from the nonwoven fabric, and the nonwoven fabric was stuck so that the adhesive layer thereof was brought into contact with one face of the same ink-receiving porous sheet as used in (1) of Example 1, whereby a porous sheet laminate was prepared.

(2) Preparation of a Release Sheet-provided Laminate Material for a Protective Layer

The same procedure as in (2) of Example 1 was repeated to prepare a release sheet-provided laminate material for a protective layer, except that in (2) of Example 1, used as a transparent acryl base adhesive was the compound (brand name: LS401E, manufactured by Lintec Co., Ltd.) prepared by adding 1.5 part by weight of a benzotriazole base UV absorber to 100 parts by weight of the solid matter.

(3) Preparation of a Water Resistant Display Sheet

Used were the porous sheet laminate obtained in (1) described above and the release sheet-provided laminate material for a protective layer obtained in (2) described above to prepare a water resistant display sheet having a whole thickness of 565 μm in the same manner as in (3) of Example 1.

### Example 5

The same procedure as in Example 4 was repeated to prepare a water resistant display sheet having a whole thickness of 430 μm, except that foamed polyurethane sheet having a thickness of 80 μm in which a lot of holes communicated and which had continuous bubbles was substituted for the nonwoven fabric.

### Comparative Example 1

(1) Preparation of a Porous Sheet Laminate

The same procedure as in (1) of Example 3 was repeated to prepare a porous sheet laminate having a whole thickness of 340 μm, except that in (1) of Example 3, the acryl base adhesive (brand name: PA-10, manufactured by Lintec Co., Ltd.) was substituted for the silicon base adhesive and applied so that the thickness after drying was 30 μm.

(2) Preparation of a Release Sheet-provided Laminate Material for a Protective Layer

The same procedure as in (2) of Example 1 was repeated to prepare a release sheet-provided laminate material for a protective layer.

(3) Preparation of Display Sheet

Used were the porous sheet laminate obtained in (1) described above and the release sheet-provided laminate material for a protective layer obtained in (2) described above to prepare a display sheet having a whole thickness of 415 μm in the same manner as in (3) of Example 1.

The water resistant display sheets prepared in Examples 1 to 5 and the display sheet prepared in Comparative Example 1 were subjected to an outdoor display test to evaluate the deficiency of the appearance thereof. The results thereof are shown in Table 1.

TABLE 1

| | | | | | | Comparative |
|---|---|---|---|---|---|---|
| | Example | | | | | Example |
| | 1 | 2 | 3 | 4 | 5 | 1 |
| Presence of | ∘ | ∘ | ∘ | ∘ | ∘ | × |
| deficient appearance | | | | | | |

The acryl base adhesive used in Example 1 and the silicon base adhesive used in Example 3 were subjected to a moisture permeability test, and the results thereof are shown in Table 2.

TABLE 2

| | Moisture permeability |
|---|---|
| Adhesive | (g/cm² · 24 hours) |
| Acryl base adhesive | 1600 |
| Silicon base adhesive | 7300 |

### EFFECTS OF THE INVENTION

According to the present invention, capable of being given is a display sheet having an excellent water resistance, in which the protective layer is inhibited from rising or peeling off from a printing layer or the water resistant display sheet is inhibited from rising or peeling off from an adhered matter caused by penetration of water and water vapor from the end face of the ink-receiving porous sheet. Also, the porous sheet laminate to which various printing and recording methods as well as an ink jet recording method can be applied can readily be obtained.

Further, the water resistant display sheet of the present invention does not have to be subjected to complicated end face-sealing treatment and therefore has a low production cost.

What is claimed is:

1. A porous sheet laminate comprising a release sheet, an ink-receiving porous sheet and provided therebetween an adhesive layer endowed with a water-passing property.

2. The porous sheet laminate as described in claim 1, wherein the adhesive layer is provided with a concave groove or an irregularity part to be endowed with a water-passing property.

3. The porous sheet laminate as described in claim 1, wherein a water vapor-permeating adhesive is used for the adhesive layer to be endowed with a water-passing property.

4. The porous sheet laminate as described in claim 1, wherein a sheet having pores is inserted into the adhesive layer to endow it with a water-passing property.

5. A water resistant display sheet prepared by providing in order a printing layer and a protective layer on the surface of the ink-receiving porous sheet in the porous sheet laminate as described in any of claims 1 to 4.

6. The water resistant display sheet as described in claim 5, wherein it is used for ink jet printing.
